(19) United States
(12) Patent Application Publication
(10) Pub. No.: US 2012/0227226 A1
(43) Pub. Date: Sep. 13, 2012

(54) CLIP

(75) Inventor: Yuji Sasaki, Toyota-shi, (JP)

(73) Assignee: NIFCO INC., Yokohama-shi, (JP)

(21) Appl. No.: 13/511,271

(22) PCT Filed: Dec. 9, 2010
(86) PCT No.: PCT/JP2010/072142

§ 371 Date: May 22, 2012

(30) Foreign Application Priority Data
Dec. 10, 2009 (JP) JP2009-280290

(51) Int. Cl. F16B 19/00

(52) U.S. Cl. 24/703.1

(57) ABSTRACT

A clip includes a head part, and a leg part, and allows pushing-in of the leg part into a mounting hole provided in an object to be clipped by elastically deforming one part of the leg part and clips on the object to be clipped by sandwiching the object to be clipped between the head part and the one part of the leg part by elastically returning the one part of the leg part back to its original state at a pushing-in finish position of the leg part. The leg part includes a non-deformable part, and a deformable part extending from the non-deformable part which becomes the one part of the leg part, and both the tip of the deformable part and the base portion linked to the non-deformable part are formed to extend along a virtual spiral around the central axis of the leg part.

### FIELD OF THE INVENTION

The invention relates to an improvement of a clip which clips on an object to be clipped by pushing a leg part thereof into a mounting hole provided in the object to be clipped.

### BACKGROUND ART

There is a clip configured such that the elastic section which elastically deforms when it is inserted into a mounting hole formed in a location (object to be clipped) comprises a support pillar and a plurality of blade portions extending to an outside direction from about overall length of the support pillar and formed in a tabular shape and that the tip of the blade portions are disposed along a virtual spiral around the support pillar. (See Patent Document 1) When the tip of the elastic portion is disposed along a spiral in this way, even when the clip is pushed into a mounting hole without being twisted, an advantageous effect same as when it is twisted can be obtained and thus smoothness in being pushed into a mounting hole or insertability thereinto can be improved.

However, in such a clip, even though the tip of the blade portion extends along a virtual spiral, because its base portion remains simply linked to the support pillar portion along the lengthwise direction of the support pillar portion, the deformation center of the blade portion which has the tip of the blade portion as its power point is always located in the inside of the portion of the tip which is pressed against the mounting hole. Thus, such a clip, while having the tip of the blade portion extends along a spiral, needs a force suitable for the rigidity of the blade portion to deform the blade portion, so that limitations exist in reducing the insertion force or the force required for the pushing-in into the mounting hole.

### PRIOR ART DOCUMENT

### Patent Document

Patent document 1:

### Japanese Patent No. 3768308

### SUMMARY OF THE INVENTION

### Problems to be Solved by the Invention

The main problem that the invention is going to solve is to effectively reduce the insertion force of this kind of clip into the mounting hole provided in the object to be clipped without damaging the function of the clip.

### Means of Solving the Problems

To achieve the problem, in this invention, a clip comprises a head part and a leg part, and allows pushing-in of the leg part into a mounting hole provided in an object to be clipped by elastically deforming a part of the leg part, and clips on the object to be clipped by sandwiching the object to be clipped between the head part and the part of the leg part by elastically returning the part of the leg part back to its original state at the pushing-in finish position of the leg part,

the leg part comprises a non-deformable part, and a deformable part extending from the non-deformable part which becomes the part of the leg part, and

both the tip of the deformable part and the base portion linked to the non-deformable part are formed along a virtual spiral around the central axis of the leg part

Further, it is one of the preferred embodiments that in a cross section of a direction at right angles to the central axis of the leg part, the deformable part is configured to form a fin shape comprising an inside surface facing the central axis and an outside surface which comes to stand back to back to the inside surface.

When the leg part is pushed into the mounting hole of the object to be clipped, the tip of the deformable part is pressed against the mounting hole side to make the deformable part deform elastically and the leg part is allowed to be pushed into the mounting hole. Because the deformable part is configured such that the tip and the base portion linked to the non deformable part are formed to extend along the virtual spiral, the deformation center of the deformable part that has the tip as its power point is not located in the inside of the portion pressed against the mounting hole in the tip and is always located in the base portion which is located farther to the side of the insertion to the mounting hole in the leg part than the inside of the portion pressed against the mounting hole in the tip. That is to say, in the push-in process, the deformation center with respect to the power point is either located in the insertion leading side of the leg part in the mounting hole or has already left away from the mounting hole. As a result, according to the clip, the insertion force or force required for the pushing-in of the leg part into the mounting hole can be reduced effectively. Further, if the deformable part is configured to have a fin shape having the outside surface, when the leg part thereof is pushed into the mounting hole, while having the outside surface along the virtual spiral facially touch the side of the mounting hole, the deformable part is deformed in a direction approaching the central axis thus to make wear and tear hard in the pushing-in.

### Effect of the Invention

According to the invention, the insertion force of the leg part into the mounting hole provided in the object to be clipped can be reduced effectively without damaging the function of the clip. Thus, wear and tear of the leg part is hard to occur, and the clip of the invention has characteristic to endure repeated use.

### BRIEF DESCRIPTION OF THE DRAWINGS

FIG. 1 is a front view of a clip pertaining to one embodiment for carrying out the invention, indicating an object to be clipped with imaginary outlines at the same time.

FIG. 2 is a right side view of the clip.

FIG. 3 is a sectional view taken along line A-A in FIG. 1.

FIG. 4 is a sectional view taken along line B-B in FIG. 1.

FIG. 5 is a sectional view taken along line C-C in FIG. 1.

FIG. 6 is a sectional view taken along line D-D in FIG. 1.

### EMBODIMENTS FOR CARRYING OUT THE INVENTION

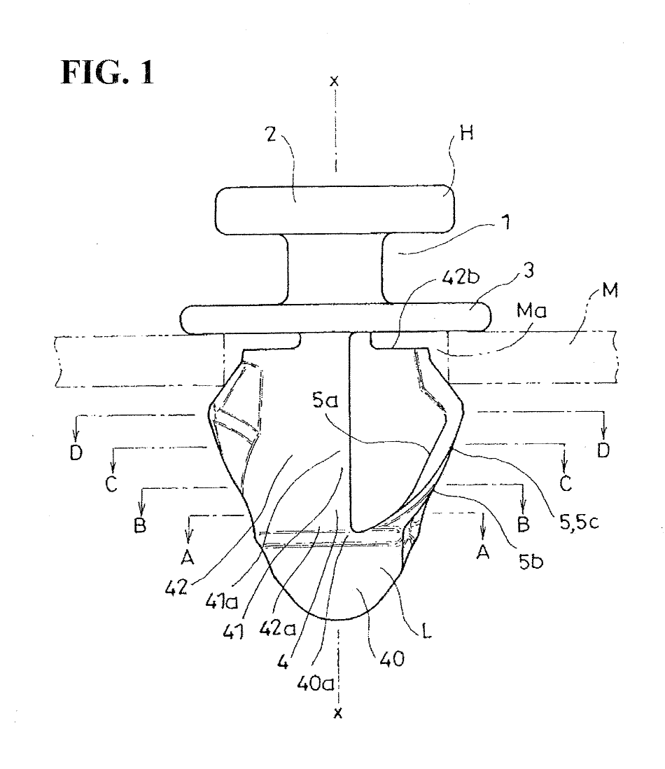

Hereinafter, a typical embodiment for carrying out this invention is explained based on FIG. 1 to FIG. 6. A clip according to the preferred embodiment of the invention, through pushing leg part L into mounting hole Ma provided in an object to be clipped M, clips on an object to be clipped M. By pushing the leg part L into the mounting holes Ma from a state wherein a plurality of objects to be clipped M provided in mounting hole Ma, or typically, a plurality of panels is stacked so that respective mounting holes Ma are made to communicate with each other, the clip can be used to clip together the plurality of objects to be clipped M therethrough. Further, the clip can be made such that amounting portion and/or a clipping portion of another object is formed in head H which does not enter the mounting hole Ma. And in this way, the object to be clipped M can be connected to the another object through a clip.

In this preferred embodiment of the invention, the clip has head H and leg part L, and is adapted to be mounted or attached to another object by means of the head H.

A clip, as a whole, forms an almost shaft-like shape and is configured to make its shaft axis x as a virtual central axis of leg part L. Head H has a size which does not enter mounting hole Ma of the object to be clipped M. In the depicted example, the head H has orbiting groove 1 around the shaft axis x and is configured to have top portion 2 forming a disc-like shape by the orbiting groove 1 and flange part 3 forming a disc-like shape with a diameter larger than that of top portion 2. In the depicted example, typically, from a state where the portion upper than flange part 3 in the clip is passed through the large diameter portion of a top joint hole formed in another object which is not illustrated, by moving the clip or causing a relative movement of the clip to a direction at right angles to the shaft axis x to make orbiting groove 1 enter the small diameter portion of the top joint hole, head H is allowed to be mounted to the another object by sandwiching one part of another object between top portion 2 and flange part 3.

Leg part L is configured to be pushed into mounting hole Ma provided in the object to be clipped M by elastically deforming one part of leg part M and clips on the object to be clipped M by sandwiching the object to be clipped M between head part H and the one part of leg part L by elastically returning the one part of leg part L back to its original state at the pushing-in finish position of leg part L. And the leg part L comprises non-deformable part 4 and deformable part 5 extending from the non-deformable part 4 which becomes the one part of leg part L.

In the depicted example, the leg part L is formed to protrude from the head H along the shaft axis x. Leg part L comprises terminal portion 40 forming a hemispherical shape, core 41 extending between terminal portion 40 and head H, arm portion 42 extending from core 41 along the circular arc of imaginary circle r around the shaft axis x, and deformable part 5 projecting from the arm portion 42 outwardly of the circular arc of the imaginary circle r. The diameter of the imaginary circle r is set to be approximately equal to the bore diameter of the mounting hole Ma, and terminal portion 40, core 41 and arm portion 42 function as the non deformable part 4. In the depicted example, the outside diameter of linking side 40a with core 41 in terminal portion 40 is approximately equal to the bore diameter of the mounting hole Ma, and core 41 forms a plate shape having a width approximately equal to the bore diameter of the mounting hole Ma. Arm sections 42 are respectively formed on both sides across core 41. Each arm portion 42 is configured to form one part of the cylindrical wall of a virtual cylinder which has the shaft axis x as its tube shaft and has an inside surface and outside surface. One of arm portions 42 extends along the circular arc of the virtual circle r from one edge 41a along the lengthwise direction of core 41. Further, the other of arm portions 42 extends from the other edge 41a along the lengthwise direction of core 41, along the circular arc of the virtual circle r in the same direction as that of the one arm portion 42 (a clockwise direction in FIG. 3-FIG. 6). Bottom edge 42a of arm portion 42 is linked to terminal portion 40 integrally, and top edge 42b of arm portion 42 and flange part 3 are divided to form a clearance therebetween.

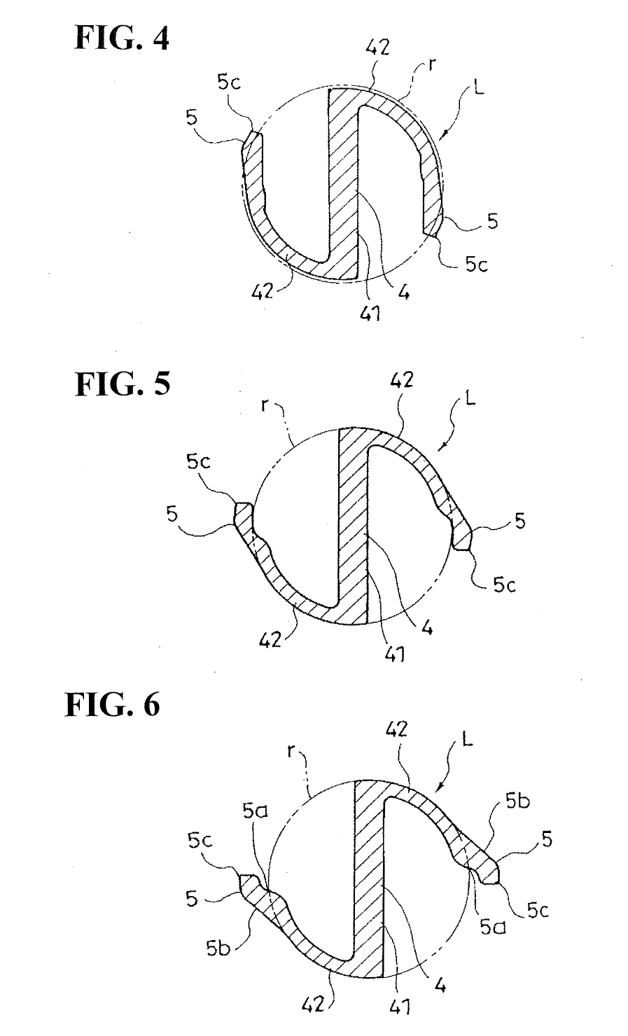

Deformable part 5 projects from the flared edge or arm edge 42c of arm portion 42 which forms non deformable part 4. Further, in a cross section in a direction at right angles to the shaft axis x or the central axis of leg part L, the deformable part is configured to form a fin shape comprising an inside surface 5a facing the central axis and an outside surface 5b which comes to stand back to back to the inside surface 5a. In the depicted example, deformable part 5 is located in the circular arc of the virtual circle r in the terminal portion 40 side; (FIG. 3) as it moves toward the head H side from the circular arc of the virtual circle r in the terminal portion 40 side, tip 5c side gradually extends outwardly of the circular arc of the virtual circle r; (FIG. 4→FIG. 5→FIG. 6) leg part L is thickest in the position in FIG. 6; and (the largest diameter) as it moves toward the top edge of arm portion 42 from there, it gradually reduces the extending amount from non deformable part 4. That is say, deformable part 5 is formed to extend from arm edge 42c between top edge 42b and bottom edge 42a of arm portion 42. Further, tip 5c of the deformable part 5 and base 5d (connection portion to arm edge 42c of the arm portion 42 in deformable part 5) which is linked to non deformable part 4 are both formed to extend along a virtual spiral around the central axis of the leg part L. Further, in the depicted example, deformable part 5 becomes the thickest in the terminal portion 40 side, (FIG. 3) and becomes thinner in the remaining portion. (FIG. 4-FIG. 6)

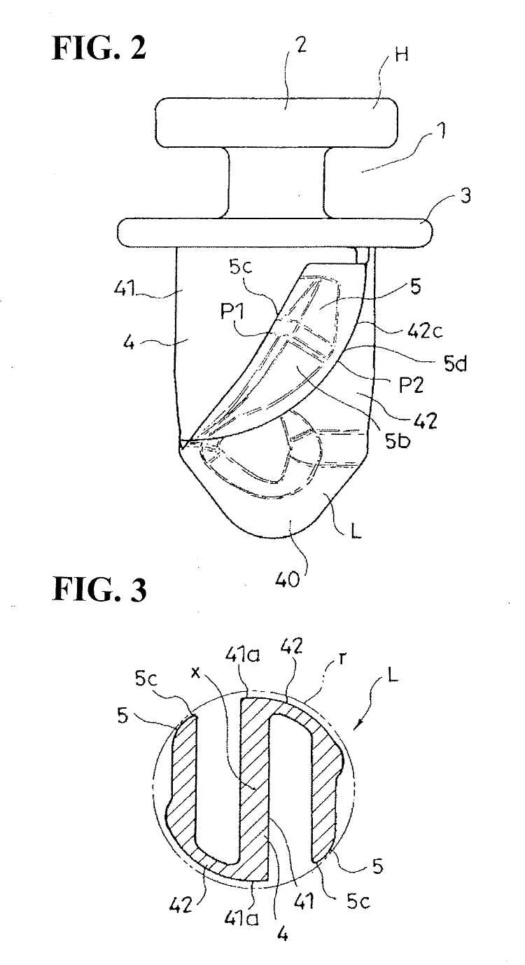

When leg part L is pushed into mounting hole Ma of the object to be clipped M, tip 5c of deformable part 5 is pressed against the mounting hole Ma side to make deformable part 5 elastically deform and leg part L is allowed to be pushed into the mounting hole Ma. Because deformable part 5 is configured such that the base portion linked to the tip 5c and non deformable part 4 extend along the virtual spiral, the deformation center of deformable part 5 that has tip 5c as its power point is not located in the inside of the portion pressed against mounting hole Ma in tip 5c and is always located in base portion 5d which is located farther to the insertion side for mounting hole Ma in leg part L than that portion. For example, when the portion which is indicated by sign P1 in FIG. 2 is pressed against mounting hole Ma side, the deformation center of deformable part 5 lies in the portion indicated by sign P2 in FIG. 2. That is to say, in the push-in process, with respect to the power point, the deformation center is located either in the insertion side of leg part L in mounting hole Ma or has already passed away from the mounting hole Ma. As a result, according to the clip, insertion force or force required for pushing leg part L into mounting hole Ma can be reduced effectively. Further, because deformable part 5 is configured to form a fin shape comprising the outside surface 5b, when leg part L is pushed into mounting hole Ma, while having the outside surface 5b provided to extend along the virtual spiral facially touch the side of the mounting hole Ma, deformable part 5 is deformed in a direction approaching the central axis thus making wear and tear hard to occur in the pushing-in. In the depicted example, the position where flange part 3 of head H abuts against one side of the object to be clipped M becomes a pushing-in finish position of leg part L, and because in such pushing-in finish position, the largest diameter portion of leg part L has already passed away therefrom to the other side of the object to be clipped M, the clip clips on the object to be clipped M (FIG. 1) by sandwiching the object to be clipped M between deformable part 5 which has elastically returned back to its original state and flange part 3.

In a clip as described above, typically, the provision of elastically deformable property to the portion which should have such elastically deformable property can be easily and suitably obtained by making or molding such clip by a synthetic resin.

All contents of the specification, claims, drawings and figures of Japanese Patent Application No. 2009-280290 filed on Dec. 10, 2009 are incorporated herein by reference, as a disclosure of the specification of this invention.

What is claimed is:

1. A clip comprising a head part, and a leg part, the clip allowing pushing-in of the leg part into a mounting hole provided in an object to be clipped by elastically deforming one part of the leg part and clipping on the object to be clipped by sandwiching the object to be clipped between the head part and the one part of the leg part by elastically returning the one part of the leg part back to its original state at a pushing-in finish position of the leg part,
wherein the leg part comprises a non-deformable part and a deformable part extending from the non-deformable part which becomes the one part of the leg part, and
a tip of the deformable part and a base portion linked to the non-deformable part are formed to extend along a virtual spiral around a central axis of the leg part.

2. A clip according to claim 1, wherein the deformable part is configured, in a cross section in a direction at right angles to the central axis of the leg part, to forma fin shape comprising an inside surface facing the central axis and an outside surface which stands back to back to the inside surface.
